(19) United States
(12) Patent Application Publication
(10) Pub. No.: US 2010/0220405 A1
(43) Pub. Date: Sep. 2, 2010

(54) DRIVING METHOD OF LENS ACTUATOR

(75) Inventors: Sze Keat Chee, Tokyo (JP); Takeshi Yano, Tokyo (JP); Tomoyuki Kugou, Tokyo (JP)

Correspondence Address: Studebaker & Brackett PC, One Fountain Square, 11911 Freedom Drive, Suite 750, Reston, VA, 20190, US

(73) Assignees: NAMIKI SEIMITSU HOUSEKI KABUSHIKI KAISHA, Tokyo (JP); YUUGENGAISYA MECHANO TRANSFORMER, Kanagawa (JP)

(21) Appl. No.: 12/670,345

(22) PCT Filed: Jul. 28, 2008
(86) PCT No.: PCT/JP2008/063489

§ 371 Date: Jan. 22, 2010

(30) Foreign Application Priority Data
Aug. 1, 2007 (JP) 2007-200255

(51) Int. Cl. G02B 7/04; G02B 7/02

(52) U.S. Cl. 359/824; 359/822

(57) ABSTRACT

(Problem) To suppress vibration generated while rising of a reciprocating lens actuator using a piezoelectric element or the like as a driving source and to shorten a rising speed.

(Solving Means) By setting a time of a rising portion to a period corresponding to a natural frequency of a driving source, it is possible to prevent resonance of the driving source while rising so as to suppress vibration after rising and to increase a rising speed. In addition, by returning to an original point before driving, it is possible to improve reproducibility of movement displacement of the input signal.

### TECHNICAL FIELD

The present invention relates to a method of driving a reciprocating lens actuator using linear direction force of a piezoelectric element or the like as a driving source.

### BACKGROUND OF THE INVENTION

Currently, in a small-sized lens actuator mounted in a mobile telephone or the like, it is difficult to use a rotational lens barrel which has been conventionally used, due to a limit of a mounting space. Accordingly, a reciprocating structure in which a lens moves by a piezoelectric element, a movable coil or the like is widely used.

When such a lens actuator is driven, if a piezoelectric element is used, a movement amount by one input is small. Therefore, there is a problem that it is difficult to shorten an arrival time to a target position.

In addition, in a movable coil type structure, since damping occurs after movement, there is a problem that it is difficult to shorten an arrival time to a target position, similar to the case of using the piezoelectric element.

The problem which happens in the piezoelectric element type structure of the above-described two problems is solved by inputting a value higher than an amount necessary for displacement of a target value in advance.

### SUMMARY OF THE INVENTION

However, in the solving method about the piezoelectric element type structure, since the input value is set to be higher than the target value so as to improve quick responsiveness, an entire device driven by the piezoelectric element of a driving source is vibrated, and there is a problem that it is difficult to determine a focal position of the lens attached to the device, as compared with the case where a general input is performed.

In addition, as a solving method using the related art associated with damping different from the solving method about the piezoelectric element type structure, there is a method of driving a piezoelectric actuator for an ink jet printer described in Japanese Unexamined Patent Application Publication No. 11-342608 (hereinafter, referred to as Patent Document 1).

The driving method described in Patent Document 1 is characterized in that a damper effect by the volume of an ink container is incorporated into a vibration system of the actuator. By incorporating the damper effect, damping is suppressed so as to shorten a rising time of the actuator.

However, in order to obtain the same effect by applying the driving method described in Patent Document 1 to a lens actuator, a separate damper element needs to be added. This is because a damper element of a vibration system is small in view of the structure of the lens actuator and thus a driving method of changing an input voltage by a focal length corresponding to an object to be photographed is used.

### Means for Solving the Problems

In order to solve the above problems, the present invention is characterized in that a rising time of an input signal is adjusted to be close to a period corresponding to a natural frequency of a lens actuator in a driving mechanism of a reciprocating lens actuator.

In more detail, the rising time is set within a range of 95 to 105% of the period corresponding to the natural frequency so as to suppress resonance of a waveform with the actuator at the time of application of a voltage such that a piezoelectric element of the lens actuator is driven.

Accordingly, by making a control signal inputted at the time of driving of the lens actuator with a rising waveform into which a waveform of a resonance frequency is not easily incorporated, it is possible to drive the lens in a short period of time while suppressing vibration after rising.

Also, in the control method, when a lens actuator of piezoelectric element type is driven using the control method, the lens moves to a target position after the lens position is returned to an initial position where a voltage is not applied.

Accordingly, it is possible to stably drive the lens with good reproducibility, regardless of a displacement difference generated at the time of expansion and contraction of the used lens actuator.

In addition to the above-described effect, in the control method of the present invention, since an optimal input signal is determined by examining a natural frequency in advance, the present invention is easily applicable to all lens actuators using linear direction force as a driving source.

### BRIEF DESCRIPTION OF THE DRAWINGS

FIG. 1 shows a lens actuator used in an embodiment of the present invention.

FIG. 2 shows a driving signal used in the embodiment of the present invention.

FIG. 3 shows rising characteristics when a driving signal of FIG. 2(a) is input to the lens actuator of FIG. 1 in a state of changing a period of the driving signal.

### DETAILED DESCRIPTION OF THE INVENTION

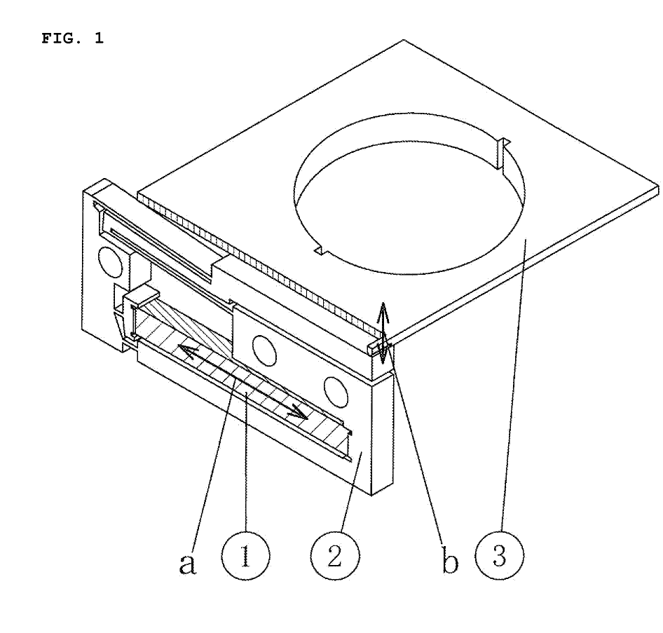

Hereinafter, the best embodiments of the present inventions will be described with reference to FIGS. 1 to 3.

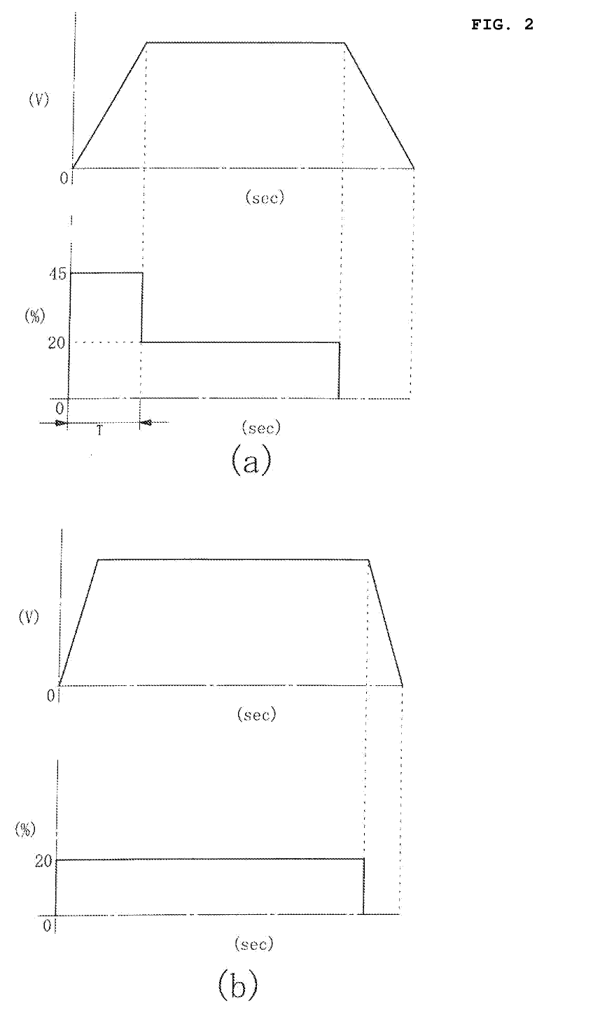

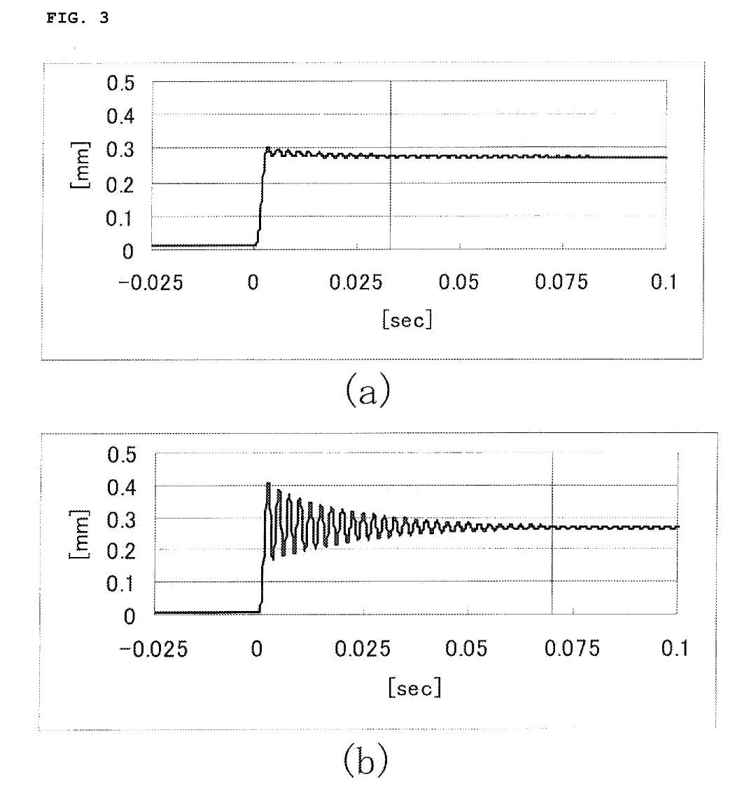

FIG. 1 shows a lens actuator used in the present embodiment, FIG. 2 shows an input waveform used when the lens actuator is driven, and FIG. 3 shows rising when the waveform of FIG. 2(a) is input in a state of changing a period thereof.

As shown in FIG. 1, the lens actuator used in the present embodiment has a structure in which a lens mounted in a lens holder is driven by using a displacement magnifying mechanism 2 disposed on the periphery of the lens holder 3 so as to magnify displacement of a piezoelectric element 1, which is a driving source, in a direction a and to perform conversion into displacement in a direction b which is an optical axis direction. Therefore, it is possible to obtain good quick responsiveness of the piezoelectric element and a sufficient movement amount by the displacement magnifying mechanism.

FIG. 2 shows two waveforms inputted to the lens actuator. Here, FIG. 2(a) shows a trapezoidal wave used in the present invention and FIG. 2(b) shows a trapezoidal wave which has been used in a conventional driving method.

In FIG. 2, in a control method of the present embodiment, a control method of changing a duty ratio at a rising portion and a duty ratio of a holding portion using a switching regulator is used. In more detail, a driving method of making the duty ratio at the rising portion denser in contrast with the conventional trapezoidal input with a constant duty ratio is used.

Therefore, the rising speed of the piezoelectric element which was conventionally fixed by a voltage can be changed without depending on an input voltage and thus at a certain rising speed can be set without inputting an excessive response waveform or the like.

In addition, by performing control along with the switching regulator, the power of the entire device is conserved and a control property can be improved because digital control is possible.

FIG. 3 shows a result of driving the lens actuator of FIG. 1 by the above signal. As shown in FIG. 3, while a rising time of FIG. 3(a) using the trapezoidal wave is 33 msec, a rising time of FIG. 3(b) is 70 msec.

This is because a time of a rising portion of an input signal of FIG. 3(a) is set to a period T corresponding to a natural frequency of the piezoelectric element. By using the above setting, it is difficult for a wave having a resonance frequency to be incorporated while rising. Accordingly, it is possible to suppress damping after driving the lens so as to shorten a rising time. In addition, FIG. 3(b) which is an object to be compared shows a driving result in which a conventional rising time is set in the signal waveform shown in FIG. 2(a).

In the present embodiment, when the lens continuously moves to a plurality of focal positions which are target positions at the time of driving of the lens actuator, a method of moving to the focal positions after returning to an original point in which the voltage is not applied is used. Accordingly, it is possible to drive the lens with good reproducibility of the input signal, without being influenced by hysteresis of the piezoelectric element at the time of expansion and contraction thereof.

Also, although the lens actuator using the piezoelectric element as the driving source is used in the present embodiment, the present invention is not limited to the piezoelectric element type driving structure with respect to the trapezoidal wave, and all lens actuators using linear direction force as a driving source, such as a voice coil type driving structure, may be used.

As described above, by using the above-described control method of the present embodiment, it is possible to drive the lens in a shorter rising time than the conventional driving method.

1. A method of driving a reciprocating lens actuator, wherein a rising time of an input signal is set to a range of 95 to 105% of a period corresponding to a natural frequency of the actuator, when the input signal is input to a driving source.

2. The method according to claim 1, wherein the method of driving the reciprocating lens actuator uses a piezoelectric element as the driving source, and a lens is driven after returning the lens actuator to an original point, at the time of adjustment of a focal position of the lens actuator.
